(19) United States
(12) Patent Application Publication
(10) Pub. No.: US 2010/0242943 A1
(43) Pub. Date: Sep. 30, 2010

(54) GRILLING APPARATUS WITH GAS ASSIST FOR CHARCOAL

(75) Inventors: David LAPORTA, Matawan, NJ (US); Gregory SCHUTTE, Palm Beach Gardens, FL (US)

Correspondence Address: LUCAS & MERCANTI, LLP, 475 PARK AVENUE SOUTH, 15TH FLOOR, NEW YORK, NY, 10016, US

(73) Assignee: GMJ DESIGN GROUP, LLC, Lake Worth, FL (US)

(21) Appl. No.: 12/412,915

(22) Filed: Mar. 27, 2009

(51) Int. Cl. A47J 37/06

(52) U.S. Cl. 126/25 B

(57) ABSTRACT

A grilling apparatus that has a cart base, two separate grill housings, including a first grill housing fixed to the cart base for cooking using gas and a second grill housing fixed to the cart base for cooking using charcoal briquettes. Both grill housings have internal cooking regions with cooking surfaces, a valve and an igniter adjacent to the internal cooking regions. The second internal cooking region has a generally horizontally orientated tray which holds charcoal briquettes. The valve and igniter of the second grill housing are adapted to be connected to the same source of gas as the valve and igniter of the first grill housing. Gas is provided to the valve of the second internal cooking region, and with the igniter, the charcoal briquettes are ignited in the second internal cooking region by directing a flame to the side of the tray.

### FIELD OF THE INVENTION

The present invention relates generally to grills used for cooking outdoors. More particularly, the present invention relates to an outdoor grill using gas and/or charcoal briquettes as the source of fuel or a combination of both where the charcoal briquettes are ignited by a flame.

### BACKGROUND OF THE INVENTION

Grills are widely used for both commercial and residential cooking. Over the years grills have been developed in a variety of shapes and sizes. Typically, grills are designed as either a gas (liquid propane (LP) or natural gas) grill or a charcoal grill. Personal preference and intended use usually dictate the type of grill a consumer or business will purchase or use. However, there are instances when a purchaser or user cannot decide between a gas grill or a charcoal grill, or wants both, especially to be able to cook different foods using different fuels. Attempts have been made to combine gas grills and charcoal grills into a single unit. However, these attempts have been met with varying degrees of success. Some charcoal grills have been provided with a gas-assist lighting system with a small disposable propane tank to ignite charcoals.

### SUMMARY OF THE INVENTION

The present invention provides a grilling apparatus that combines both a gas grill and a charcoal grill into a single unit using a gas (liquid propane (LP) or natural gas) flame directed at and to ignite the charcoal briquettes.

The present invention also provides an arrangement wherein a tray holding the charcoal briquettes is height adjustable, relative to the gas flame ignition height position.

The invention provides a grilling apparatus comprising a cart base having two separate grill cooking housings, including a first grill housing fixed to the cart base for cooking using gas, and a second grill housing fixed to the cart base for cooking using charcoal briquettes, the first grill housing having a first internal cooking region with a first cooking surface, at least a first valve and at least a first igniter located adjacent the first grill cooking region, the first valve being connected to a burner element and adapted to be connected a source of gas for heating the first grill area, a restrictor within the valve permitting adjustment of gas flow to the burner so as to control the first grill cooking region temperature, the second grill housing having a second internal cooking region, different from the first grill internal cooking region, and with a second cooking surface, a generally horizontally orientated tray for holding charcoal briquettes within the second internal cooking region, at least a second valve and at least a second igniter located adjacent the tray, the second valve and the second igniter being adapted to be connected to the same source of gas as the first valve and the first igniter, to provide gas to second valve, and with the second igniter to ignite the charcoal briquettes in the second grill internal cooking region by directing a flame to the side of the tray, to ignite charcoal briquettes on the tray.

An advantage of locating the second valve and igniter to the side of the tray is to eliminate, or at least reduce, contamination from charcoals burning close to the end of the valve and igniter.

Even though the valve and igniter are located a sufficient distance away from the edge of the tray (and charcoal on it) to protect it from contamination, the valve and orifice are arranged to project the flame a sufficient distance with sufficient force to reach the charcoal briquettes placed on the tray to thereby ignite the charcoal.

The valve and igniter are preferably arranged as a single unit, so that one turn of the valve to open the gas will also automatically cause the igniter to ignite the gas.

The invention also provides a grilling apparatus comprising a cart base having two separate grill cooking housings, including a first grill housing fixed to the cart base for cooking using gas, and a second grill housing fixed to the cart base for cooking using charcoal briquettes, the first grill housing having a first internal cooking region with a first cooking surface, at least a first valve and at least a first igniter located adjacent the first grill cooking region, the first valve being connected to a burner element and adapted to be connected a source of gas for heating the first grill area, a restrictor within the valve permitting adjustment of gas flow to the burner so as to control the first grill cooking region temperature, the second grill housing having a second internal cooking region, different from the first grill internal cooking region, and with a second cooking surface, a generally horizontally orientated tray for holding charcoal briquettes within the second internal cooking region, a second valve and second igniter located on a peripheral side of the second internal cooking region and the tray, the second valve and the second igniter being adapted to be connected to the same source of gas as the first valve and the first igniter, to provide gas to the second valve, and with the second igniter to ignite the charcoal briquettes in the second grill internal cooking region by directing a flame to the side of the tray to ignite charcoal briquettes on the tray.

The invention provides a method of using a grilling apparatus providing a cart base having two separate grill cooking housings, including a first grill housing fixed to the cart base for cooking using gas, and a second grill housing fixed to the cart base for cooking using charcoal briquettes, providing the first grill housing with a first internal cooking region including a first cooking surface, at least a first valve and at least a first igniter located adjacent the first grill cooking region, connecting the first valve to a burner element and to a source of gas providing a restrictor within the valve permitting adjustment of gas flow to the burner so as to control the first grill cooking region temperature, providing the second grill housing with a second internal cooking region, different from the first grill internal cooking region including a second cooking surface, a generally horizontally orientated tray which holds charcoal briquettes fixed within the second internal cooking region, a second valve and a second igniter located adjacent the tray, connecting the second valve and the second igniter to the same source of gas as the first valve and the first igniter, and igniting the charcoal briquettes in the second grill internal cooking region by directing a flame to the charcoal briquettes placed on the tray from the side of the tray, to contact and ignite charcoal briquettes on the tray.

### BRIEF DESCRIPTION OF THE DRAWINGS

The present invention will be better understood and appreciated by reading the following detailed description in conjunction with the accompanying drawings, in which:

FIG. 1 is a perspective view of the grilling apparatus;

FIG. 2 is a perspective view thereof with the first lid and the second lid removed;

FIG. 3 is a perspective view thereof showing an adjustable rack system and tray on which the charcoal briquettes are positioned;

FIG. 4 is a top view thereof showing both the gas and charcoal cooking regions;

FIG. 5 is a top view thereof with the top grate removed from the charcoal cooking region showing the tray on which charcoal briquettes are positioned, a valve and the starter; and

FIG. 6 is a perspective view of the valve and starter.

### DETAILED DESCRIPTION OF THE PREFERRED EMBODIMENT

A preferred embodiment of the invention will now be described, as one exemplary way to practice the invention, but the invention is not limited to the preferred embodiment.

The invention provides a grilling apparatus comprising a cart base having two separate grill cooking housings, including a first grill housing fixed to the cart base for cooking using gas, and a second grill housing fixed to the cart base for cooking using charcoal briquettes, the first grill housing having a first internal cooking region with a first cooking surface, at least a first valve and at least a first igniter located adjacent the first grill cooking region, the first valve being connected to a burner element and adapted to be connected a source of gas for heating the first grill area, a restrictor within the valve permitting adjustment of gas flow to the burner so as to control the first grill cooking region temperature, the second grill housing having a second internal cooking region, different from the first grill internal cooking region, and with a second cooking surface, a generally horizontally orientated tray for holding charcoal briquettes within the second internal cooking region, at least a second valve and at least a second igniter located adjacent the tray, the second valve and the second igniter being adapted to be connected to the same source of gas as the first valve and the first igniter, to provide gas to second valve, and with the second igniter to ignite the charcoal briquettes in the second grill internal cooking region by directing a flame to the side of the tray, to ignite charcoal briquettes on the tray.

Even though the valve and igniter are located a sufficient distance away from the edge of the tray (and charcoal on it) to protect it from contamination, the valve and orifice are arranged to project the flame a sufficient distance with sufficient force to reach the charcoal briquettes placed on the tray to thereby ignite the charcoal.

The valve and igniter are preferably arranged as a single unit, so that one turn of the valve to open the gas will also automatically cause the igniter to ignite the gas.

The second valve and the second igniter may be located on a peripheral side of the second internal cooking region and above the tray. The cart base and second grill housing may define an opening for mounting and positioning the second valve and the second igniter. The second valve may have a jet which projects a flame to contact and ignite the charcoal briquettes. The grilling apparatus may include a tray height adjustment mechanism for adjusting the tray to different height positions relative to the second grill housing. The tray height adjustment mechanism may provide a tray position and the second igniter may project a flame to contact the charcoal briquettes from beneath the tray. The tray height adjustment mechanism may provide a tray position and the second igniter may project a flame to contact the charcoal briquettes from above the tray. The tray height adjustment mechanism may provide a tray position and the second igniter may project a flame to contact the charcoal briquettes horizontally level with the tray. The source of gas may be liquid propane (LP) or natural gas. A gas tank may be included for the source of gas.

The invention also provides a grilling apparatus comprising a cart base having two separate grill cooking housings, including a first grill housing fixed to the cart base for cooking using gas, and a second grill housing fixed to the cart base for cooking using charcoal briquettes, the first grill housing having a first internal cooking region with a first cooking surface, at least a first valve and at least a first igniter located adjacent the first grill cooking region, the first valve being connected to a burner element and adapted to be connected a source of gas for heating the first grill area, a restrictor within the valve permitting adjustment of gas flow to the burner so as to control the first grill cooking region temperature, the second grill housing having a second internal cooking region, different from the first grill internal cooking region, and with a second cooking surface, a generally horizontally orientated tray for holding charcoal briquettes within the second internal cooking region, a second valve and second igniter located on a peripheral side of the second internal cooking region and the tray, the second valve and the second igniter being adapted to be connected to the same source of gas as the first valve and the first igniter, to provide gas to the second valve, and with the second igniter to ignite the charcoal briquettes in the second grill internal cooking region by directing a flame to the side of the tray to ignite charcoal briquettes on the tray.

The cart base and second grill housing may define an opening for positioning the second valve and the second igniter. An opening of the second valve may project a flame contacting and igniting the charcoal briquettes. A tray height adjustment mechanism for adjusting the tray to different height positions relative to the second grill housing may be included. The tray height adjustment mechanism may provide a tray position and the second igniter may project a flame to contact the charcoal briquettes from beneath the tray. The tray height adjustment mechanism may provide a tray position and the second igniter may project a flame to contact the charcoal briquettes from above the tray. The tray height adjustment mechanism may provide a tray position and the second igniter may project a flame to contact the charcoal briquettes from horizontally level with the tray. The source of gas may be liquid propane (LP) or natural gas. A gas tank for the source of gas may be included.

The invention also provides a method of using a grilling apparatus providing a cart base having two separate grill cooking housings, including a first grill housing fixed to the cart base for cooking using gas, and a second grill housing fixed to the cart base for cooking using charcoal briquettes, providing the first grill housing with a first internal cooking region including a first cooking surface, at least a first valve and at least a first igniter located adjacent the first grill cooking region, connecting the first valve to a burner element and to a source of gas providing a restrictor within the valve permitting adjustment of gas flow to the burner so as to control the first grill cooking region temperature, providing the second grill housing with a second internal cooking region, different from the first grill internal cooking region including a second cooking surface, a generally horizontally orientated tray which holds charcoal briquettes fixed within the second internal cooking region, a second valve and a second igniter located adjacent the tray, connecting the second valve and the second igniter to the same source of gas as the first valve and the first igniter, and igniting the charcoal briquettes in the second grill internal cooking region by directing a flame to charcoal briquettes placed on the tray from the side of the tray, to contact and ignite charcoal briquettes on the tray.

The step of igniting may comprise projecting a flame to contact the charcoal briquettes from beneath the tray. The step of igniting may comprise projecting a flame to contact the charcoal briquettes from above the tray. The step of igniting may comprise projecting a flame to contact the charcoal briquettes horizontally level with the tray.

The arrangement according to the invention is advantageous compared to other arrangements which may provide only a small spark with a small amount of gas, in that the present invention provides a side torch-like burn from a large extending flame.

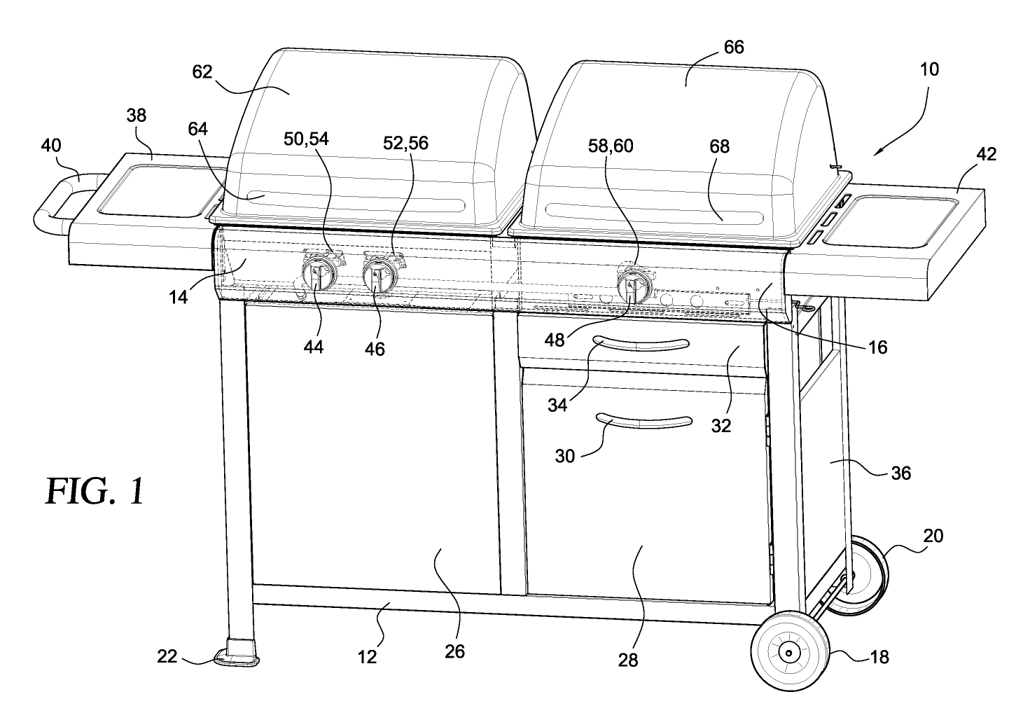

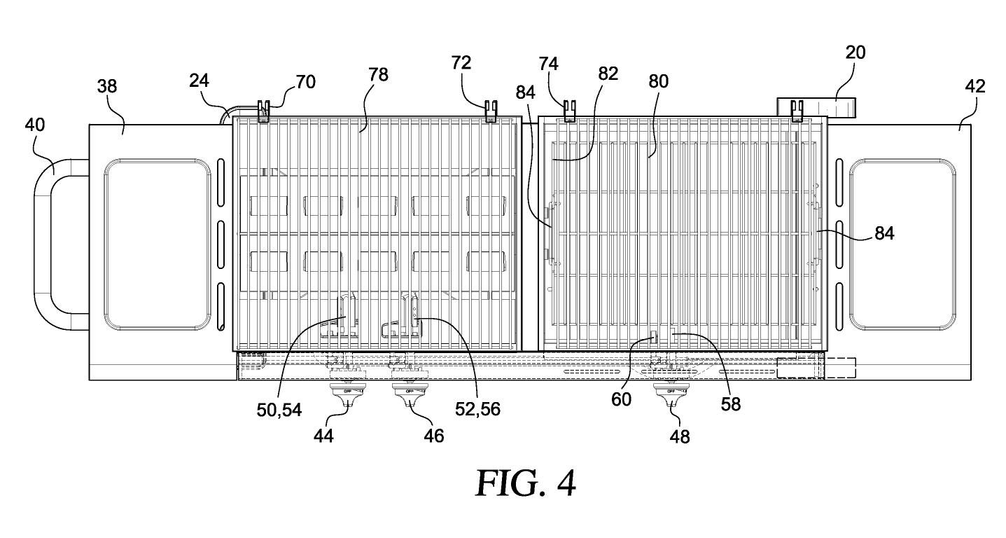

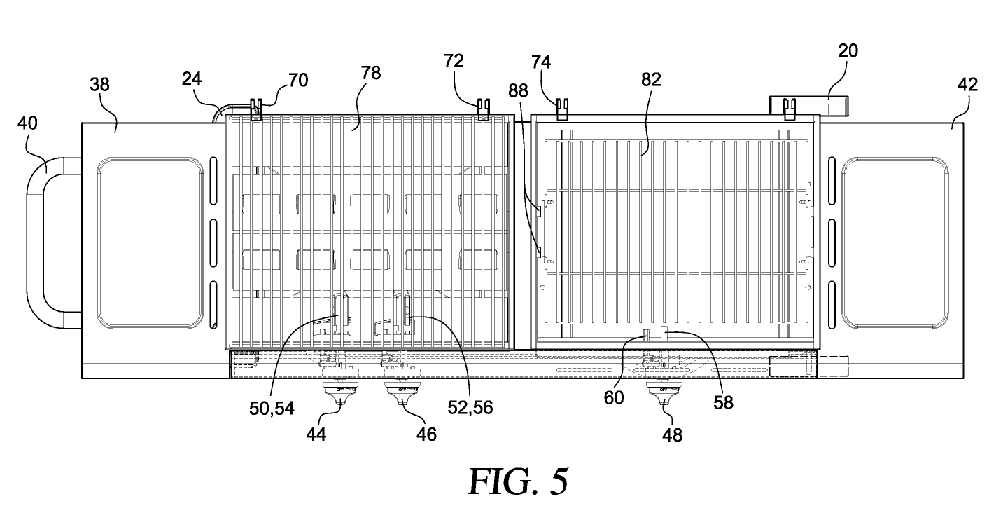

Referring now to the drawings, in which like reference numerals refer to like reference parts throughout, FIG. 1 shows a grilling apparatus 10, comprising a cart base 12, a first grill housing 14 for cooking using gas from a gas tank (not shown) and a second grill housing 16 for cooking using charcoal briquettes (not shown). The cart base 12 has two wheels 18 and 20 which aid in moving the grilling apparatus 10 and two feet 22 and 24 (see FIGS. 4 and 5) which allow the grilling apparatus 10 to rest at a desired position without moving. Additionally, the cart base 12 contains a front panel 26, a door 28 having a handle 30, a drawer 32 having a handle 34, a side panel 36, a first worktop 38 extending from the first grill housing 14 having a handle 40 and a second worktop 42 extending from the second grill housing 16.

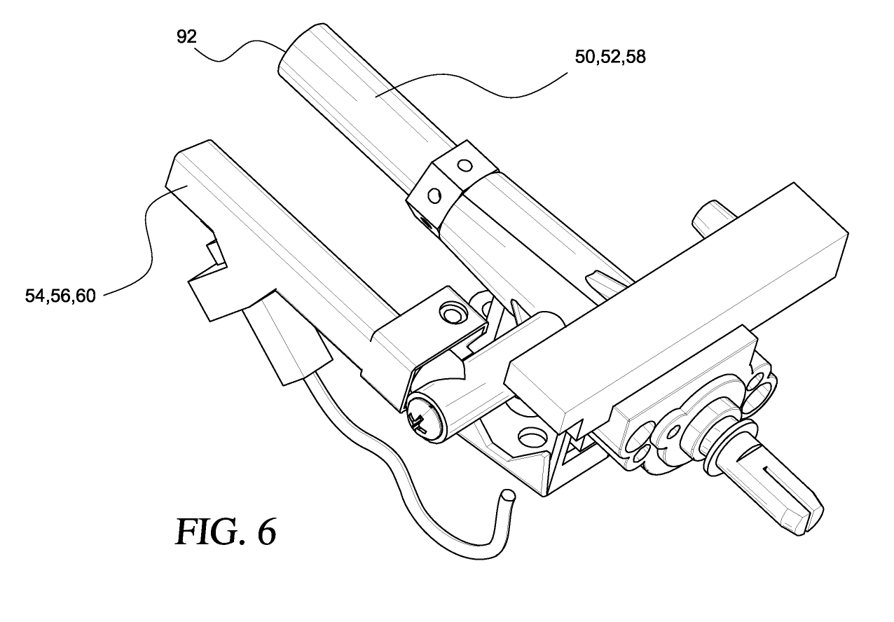

Knobs 44 and 46 are fixed respectively to valves 50, 52 and igniters 54, 56 (see also FIGS. 4-6) of the first grill housing 14. Turning knob 44 and/or knob 46 allows gas to flow from a gas tank (not shown) through a hose (not shown) connected to valve 50 and/or valve 52, and at the same time igniter 52 and/or igniter 56 is activated which aids in combustion causing a flame throughout the burner(s) (see FIGS. 4 and 5). Knob 48 is fixed to valve 58 and igniter 60 of the second grill housing 16. Turning knob 48 allows gas to flow from the gas tank through the valve 58, and to exit valve 58 at an outlet tip 94 (see FIG. 6). At the same time, igniter 60 is activated which aids in combustion causing a flame to shoot out from valve 58 outlet tip 94 (see FIG. 6) and contact the charcoal briquettes.

The valve 58 and igniter 60 are preferably arranged as a single unit, so that one turn of the valve 58 to open the gas will also automatically cause the igniter 60 to ignite the gas.

A first lid 62 is fixed atop the first grill housing 14 and has a handle 64 which is used to raise and lower the first lid 62. Additionally, a second lid 66 is fixed atop the second grill housing 16 and has a handle 60 which is used to raise and lower the second lid 66. Although the preferred embodiment has two independent lids, other configurations are possible as well.

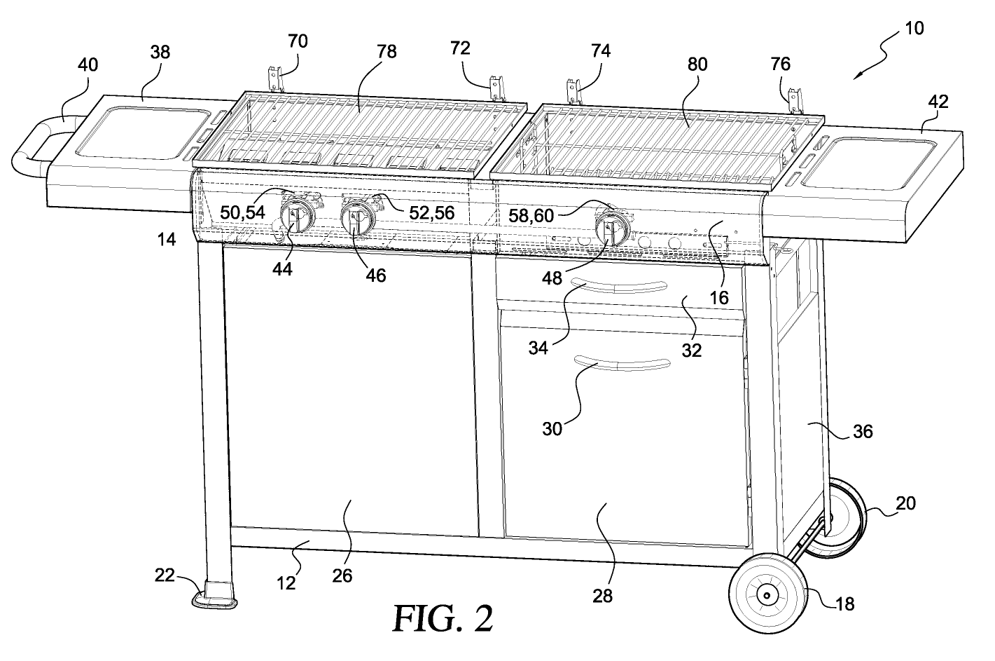

FIG. 2 further depicts the grill apparatus 10 with the first lid 62 and the second lid 66 (see FIG. 1) removed. Hinges 70, 72, 74 and 76 are used to fix the first lid 62 and the second lid 66 to the grill apparatus 10. When the grill apparatus 10 is heated, food is placed on grates 78 and 80 which are positioned atop the first grill housing 14 and the second grill housing 16 respectively.

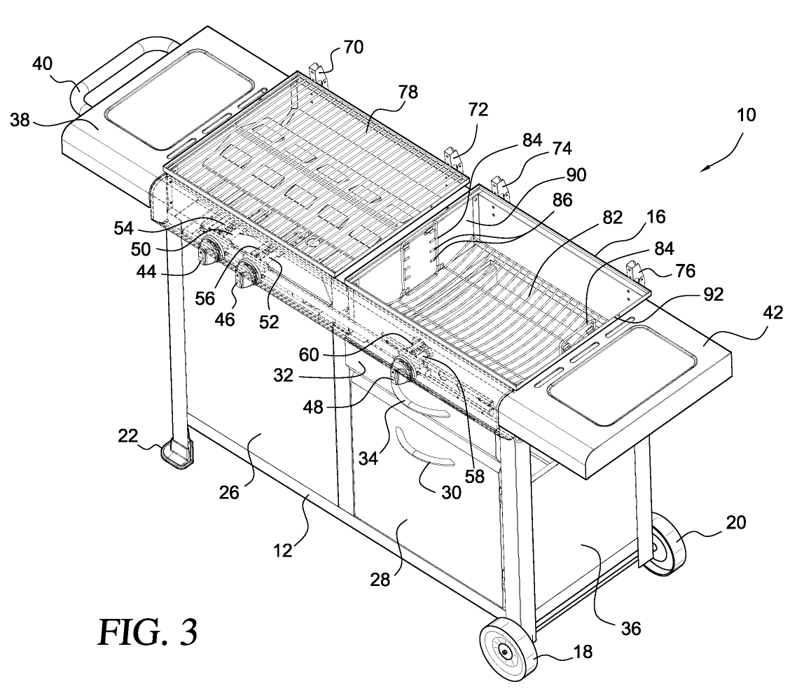

Moreover, FIG. 3 shows a tray 82 in the second grill housing 16 which holds the charcoal briquettes. The tray 82 is adjustable and can be raised or lowered to a desired height by fixing the tray 82 to a select height of a rack apparatus 84. The rack apparatus 84, which is fixed against side walls 90 and 92 of the second grill housing 16, have a plurality of metal rungs 86 which allow for adjustment and are fitted into hooks 98 fixed to the side walls 90 and 92 of the second grill housing 16. The tray 82 may be dished or scalloped with side edges higher than the middle.

As can be seen in FIGS. 4 and 5, the tray 82 is located a distance away from the valve 58 and igniter 60. This arrangement will tend to reduce contamination and/or corrosion of the valve 58 and igniter 60 from the charcoal briquette residue and food residue to at least some extent. Even though the valve 58 and igniter 60 are located a sufficient distance away from the edge of the tray 82 (and charcoal on it) to protect it from contamination, the valve 58 is arranged to project the flame a sufficient distance with sufficient force to reach the charcoal briquettes placed on the tray 82 to thereby ignite the charcoal. Alternatively, the flame from the valve 58 can be projected beneath or above the charcoal briquettes depending on whether the tray 82 is raised or lowered on the rack apparatus 84.

The valves 50, 52, 58, outlet tip 92 and igniters 52, 56, 60 are shown in further detail in FIG. 6.

The present invention has been described with reference to a preferred embodiment. It should be understood that the scope of the present invention is defined by the claims and is not intended to be limited to the specific embodiment disclosed herein.

What is claimed:

1. A grilling apparatus comprising:
a cart base having two separate grill cooking housings, including a first grill housing fixed to the cart base for cooking using gas, and a second grill housing fixed to the cart base for cooking using charcoal briquettes;
the first grill housing having a first internal cooking region with a first cooking surface, at least a first valve and at least a first igniter located adjacent the first grill cooking region, the first valve being connected to a burner element and adapted to be connected a source of gas for heating the first grill area, a restrictor within the valve permitting adjustment of gas flow to the burner so as to control the first grill cooking region temperature;
the second grill housing having a second internal cooking region, different from the first grill internal cooking region, and with a second cooking surface, a generally horizontally orientated tray for holding charcoal briquettes within the second internal cooking region, at least a second valve and at least a second igniter located adjacent the tray, the second valve and the second igniter being adapted to be connected to the same source of gas as the first valve and the first igniter, to provide gas to second valve, and with the second igniter to ignite the charcoal briquettes in the second grill internal cooking region by directing a flame to the side of the tray, to ignite charcoal briquettes on the tray.

2. The grilling apparatus of claim 1, wherein the second valve and the second igniter are located on a peripheral side of the second internal cooking region and above the tray.

3. The grilling apparatus of claim 1, wherein the cart base and second grill housing define an opening for mounting and positioning the second valve and the second igniter.

4. The grilling apparatus of claim 1, wherein of the second valve has a jet which projects a flame to contact and ignite the charcoal briquettes.

5. The grilling apparatus of claim 1, including a tray height adjustment mechanism for adjusting the tray to different height positions relative to the second grill housing.

6. The grilling apparatus of claim 5, wherein the tray height adjustment mechanism provides a tray position and the second igniter projects a flame to contact the charcoal briquettes from beneath the tray.

7. The grilling apparatus of claim 5, wherein the tray height adjustment mechanism provides a tray position and the second igniter projects a flame to contact the charcoal briquettes from above the tray.

8. The grilling apparatus of claim 5, wherein the tray height adjustment mechanism provides a tray position and the second igniter projects a flame to contact the charcoal briquettes horizontally level with the tray.

9. The grilling apparatus of claim 1, wherein the source of gas is liquid propane (LP) or natural gas.

10. The grilling apparatus of claim 1, further including a gas tank for the source of gas.

11. A grilling apparatus comprising:
a cart base having two separate grill cooking housings, including a first grill housing fixed to the cart base for cooking using gas, and a second grill housing fixed to the cart base for cooking using charcoal briquettes;
the first grill housing having a first internal cooking region with a first cooking surface, at least a first valve and at least a first igniter located adjacent the first grill cooking region, the first valve being connected to a burner element and adapted to be connected a source of gas for heating the first grill area, a restrictor within the valve permitting adjustment of gas flow to the burner so as to control the first grill cooking region temperature;
the second grill housing having a second internal cooking region, different from the first grill internal cooking region, and with a second cooking surface, a generally horizontally orientated tray for holding charcoal briquettes within the second internal cooking region, a second valve and second igniter located on a peripheral side of the second internal cooking region and the tray, the second valve and the second igniter being adapted to be connected to the same source of gas as the first valve and the first igniter, to provide gas to the second valve, and with the second igniter to ignite the charcoal briquettes in the second grill internal cooking region by directing a flame to the side of the tray to ignite charcoal briquettes on the tray.

12. The grilling apparatus of claim 11, wherein the cart base and second grill housing define an opening for positioning the second valve and the second igniter.

13. The grilling apparatus of claim 11, wherein an opening of the second valve projects a flame contacting and igniting the charcoal briquettes.

14. The grilling apparatus of claim 11, including a tray height adjustment mechanism for adjusting the tray to different height positions relative to the second grill housing.

15. The grilling apparatus of claim 14, wherein the tray height adjustment mechanism provides a tray position and the second igniter projects a flame to contact the charcoal briquettes from beneath the tray.

16. The grilling apparatus of claim 14, wherein the tray height adjustment mechanism provides a tray position and the second igniter projects a flame to contact the charcoal briquettes from above the tray.

17. The grilling apparatus of claim 14, wherein the tray height adjustment mechanism provides a tray position and the second igniter projects a flame to contact the charcoal briquettes from horizontally level with the tray.

18. The grilling apparatus of claim 11, wherein the source of gas is liquid propane (LP) or natural gas.

19. The grilling apparatus of claim 11, further including a tank for the source of gas.

20. A method of using a grilling apparatus:
providing a cart base having two separate grill cooking housings, including a first grill housing fixed to the cart base for cooking using gas, and a second grill housing fixed to the cart base for cooking using charcoal briquettes;
providing the first grill housing with a first internal cooking region including a first cooking surface, at least a first valve and at least a first igniter located adjacent the first grill cooking region, connecting the first valve to a burner element and to a source of gas providing a restrictor within the valve permitting adjustment of gas flow to the burner so as to control the first grill cooking region temperature;
providing the second grill housing with a second internal cooking region, different from the first grill internal cooking region including a second cooking surface, a generally horizontally orientated tray which holds charcoal briquettes fixed within the second internal cooking region, a second valve and a second igniter located adjacent the tray;
connecting the second valve and the second igniter to the same source of gas as the first valve and the first igniter; and
igniting charcoal briquettes in the second grill internal cooking region by directing a flame to the charcoal briquettes placed on the tray from the side of the tray, to contact and ignite charcoal briquettes on the tray.

21. The method of claim 20, wherein the step of igniting comprises projecting a flame to contact the charcoal briquettes from beneath the tray.

22. The method of claim 20, wherein the step of igniting comprises projecting a flame to contact the charcoal briquettes from above the tray.

23. The method of claim 20, wherein the step of igniting comprises projecting a flame to contact the charcoal briquettes horizontally level with the tray.
